(19) United States
(12) Patent Application Publication
(10) Pub. No.: US 2012/0249371 A1
(43) Pub. Date: Oct. 4, 2012

(54) DIRECTIONAL RADIO-SIGNAL-DETECTION APPARATUS AND METHODS OF USE

(76) Inventor: Son Nguyen, Westminster, CO (US)

(21) Appl. No.: 13/394,722

(22) PCT Filed: Mar. 29, 2011
(86) PCT No.: PCT/US11/30403

§ 371 Date: Mar. 7, 2012

(51) Int. Cl. G01S 3/14

(52) U.S. Cl. 342/442

(57) ABSTRACT

An apparatus for direction-finding a received radio signal is disclosed. The receiving apparatus selectively receives on a predetermined frequency to match the transmitter frequency. The receiving apparatus comprises of two or three antennas, including one or two loop antennas that work in conjunction with a third reference antenna (whose phase does not vary when its orientation changes relative to the transmitter), such as a dipole, monopole or helical antenna. By comparing the phase between the antennas the direction of the incoming RF signal can be determined. In some embodiments, the windings of the two loop antennas are wound in reverse with respect to each other in order to substantially double the sensitivity of the signal-detection capabilities.

### BACKGROUND

Directional radio-signal detectors are used in conjunction with radio-signal-emitting beacons in order to determine the physical locations of vehicles or persons carrying such beacons. For example, Emergency Position-Indicating Radio Beacons (EPIRBs) are used with ships and boats, Emergency Location Transmitters (ELTs) are often incorporated in aircraft, and individuals may carry a Personal Locator or other similar portable or hand-held device. For such devices to be effective for those relying on them for safety reasons, there is a requirement that the directional radio-signal equipment used to find the beacons be relatively small, accurate, easy-to-use, and be able to provide unambiguous direction determinations.

Direction finding (DF) systems can be classified as having one antenna or multiple antennas. Some of the most popular and simplest methods use single-directional antennas such as Yagis (that is, a directional antennae comprising an array of dipoles coupled with various parasitic elements) or loop (single or multi-turn) antennas. The drawback of these antennas is that the antennas are often large and must use the signal strength to indicate the direction of the radio-frequency (RF) source. In varying signal conditions, such as in a man-overboard situation, wherein the received signal strength is varying or the beam width of the antenna is large, the maximum signal level can be hard to determine. Thus these devices have low precision and accuracy.

With a single-loop antenna system, there is an ambiguity of 180 degrees. To help address this problem, multi-antenna systems or phased-array antennas were developed. One example of this type of system is what is commonly known as a Doppler or Pseudo-Doppler DF system. Doppler systems use three or more antennas and electronically rotate the antennas. The first description of direction finding using Doppler was by H. Y. Budenbom in 1947. The physical spacing of the antennas determined the amount of phase difference between the antennas. Typically the antennas are spaced at approximately ¼ wavelengths. Thus, for applications in the VHF or lower frequency range, a hand-held system is often not practical because of the resultant large size. Unfortunately, the closer the antennas are together (in order to make the unit more portable), the more sensitive it is to noise and multi-pathing, since the signal to noise ratio for determining the direction is worse.

To avoid the undesirable characteristics of the Doppler system, as well as those of systems using antenna spacing to calculate the phase difference between the antennas, an improvement over the existing art would be the creation of a directional radio-signal-detection system wherein the phase signal generated does not depend on the distance between the antennas and thus is much more practical for hand held applications.

Dual-loop antenna systems have been used for some time for directional finding purposes; however, they give ambiguous 180-degree direction indications. To address this problem, the use of a third sense or reference antenna that does not change based on the incident RF angle has been used in the art. See, for example:
U.S. Pat. No. 4,489,327 to Eastwell;
U.S. Pat. No. 4,307,402 to Watanabe;
U.S. Pat. No. 3,967,280 to Mayer et al.; and
U.S. Pat. No. 4,121,216 to Bunch.

Existing dual-loop antenna systems that also incorporate a reference antenna make use of the summing and/or difference of the loop antenna signals with the reference antenna signal to determine incident RF angle. Moreover, these types of existing systems require that a loop antenna has an amplitude component that is dependent on the angle of the incident RF signal so that the summation of the loop antenna's signal with the reference antenna's signal will create a composite signal having a composite amplitude and a composite phase of the two antennas (loop and reference). Existing dual-loop antenna systems also require that the phase of each of the loops in the antennas remains relatively constant, yet different than, the phase of the other loop antenna over a defined incident angle or rotation. Typically, this limits the design to small-loop antennas, with the preference that the antennas are located near each other. Moreover, in a typical dual-loop antenna system in the art, the loop antennas are required to be orthogonal to each other, which can also have an undesirable impact on the sizing of the systems. What would be preferred in a new directional radio-signal-detection system is the ability to allow the antennas to be disposed at almost any angle to relative to each other, which once again would facilitate a more-robust and compact design.

What would be also advantageous for a directional radio-signal-detection system is to be able to eliminate the need to use a summing and difference calculation of the RF signal, as discussed above, and instead be able to use a direct-phase comparison technique. A direct-phase comparison would require that the phase of each of the antennas changes when the incident RF angle changes, either abruptly or continuously. In turn, by being able to use a direct-phase comparison technique, a dual-loop antenna system could then use either or both small-loop and medium-loop antennas, thus allowing greater design flexibility.

In addition, using the direct-phase comparison technique, the antennas would not be required to have a specific gain pattern. Thus, if one or more medium-loop antennas could be used in a new system, then the loop antenna-gain pattern could be improved (that is, a better sensitivity to an RF signal could be realized), thus allowing a greater receive range for the system.

However, a medium-loop antenna phase response is not as sharp like a small-loop antenna (with the phase response being zero or 180 degrees), and unlike a one-wavelength-loop antenna which has no phase response, the medium-loop antenna phase response is soft and varies based on the incident RF angle. Consequently, and new directional radio-signal-detection system that uses a medium-loop antenna must also be able to effectively use this characteristic of the medium-loop antenna to determine the incident RF signal.

### BRIEF DESCRIPTION OF THE DRAWINGS

FIG. 1A depicts the typical characteristics for a small-loop antenna, and shows that as the H̅ field (magnetic field) enters from one side ( H̅1) the current flows in one direction (Ī1) and when the H̅ field enters from the opposite direction ( H̅2) the current phase (Ī2) reverses.

FIG. 1B depicts the typical characteristics for small-loop antenna when the small-loop antenna in FIG. 1A is rotated relative to the incoming RF signal by angle θ.

FIG. 1C depicts the phase response when the small-loop antenna in FIG. 1A is rotated relative to the incoming RF signal. Given that the RF signal is coming from the top and θ is the angle of the antenna relative to the horizontal axis as shown in the drawings, the phase response is constant when θ is greater than 0 and less than 180 degrees. The phase from the antenna will flip 180 degrees when the angle is greater than 180 degrees and less than 360 degrees. The phase shift is sharp for a small-loop antenna since the magnetic field enters the antenna from either one side or the other and its response to the electric field is minimal. The phase response of a small-loop antenna is either 0 or 180 degrees.

FIG. 1D depicts a typical profile of a small-loop antenna gain response.

FIG. 2A depicts the typical characteristics for a large, one-wavelength, loop antenna. The large-loop antenna response (that is, the current Ī1) is primarily to the electric field Ē.

FIG. 2B depicts the typical characteristics for large-loop antenna when the large, one-wavelength, loop antenna in FIG. 2A is rotated relative to the incoming RF signal by angle θ.

FIG. 2C depicts the phase response when the large, one-wavelength, loop antenna in FIG. 2A is rotated relative to the incoming RF signal. When θ varies from 0 to 360 degrees, the phase of the antenna is a constant.

FIG. 2D depicts a typical profile of the antenna-gain response of a large, one-wavelength, loop antenna gain response.

FIG. 3 is a graph of the phase response for both small-loop antennas and for medium-loop antennas.

FIG. 4 depicts one embodiment of a circuit block diagram for a system using one single-loop antenna and one reference antenna.

FIG. 5 depicts one embodiment of the antenna arrangement for a three-antenna system, shown from a top-view perspective.

FIG. 6 depicts one embodiment of a circuit block diagram for a system using three antennas.

FIG. 7 depicts an alternative embodiment of a circuit block diagram for a system using three antennas.

FIG. 8 is a graph depicting phase-detector outputs versus incident RF angle for a three-antenna system that uses two medium-loop antennas, with each loop antenna having reversed windings with respect to the other loop antenna.

FIG. 9 is a graph depicting the phase-detector outputs versus incident RF angle for medium-loop antennas having the same winding direction.

FIG. 10A is a graph depicting the phase-detector output for small-loop antennas, Ant1*(Ant2+90 degrees), with the loop antennas having reversed-loop windings.

FIG. 10B is a graph depicting the phase-detector output for small-loop antennas, Ant2*(Ant3+90 degrees), with the loop antennas having reversed-loop windings.

FIG. 10C is a graph depicting the phase-detector output for small-loop antennas, Ant3*(Ant1+90 degrees), with the loop antennas having reversed-loop windings.

FIG. 10D is a graph depicting a comparison of the three phase-detector outputs: one plot for small-loop antennas, Ant2*(Ant3+90 degrees), with the loop antennas having reversed-loop windings; a second plot for Ant3*(Ant1+90 degrees), with the loop antennas having reversed-loop windings; and a third plot for Ant1*(Ant2+90 degrees), with the loop antennas having reversed-loop windings.

### DETAILED DESCRIPTION

### Overview

The present disclosure is directed generally to a direction-finding receiver that determines the originating direction of the received radio-signal source. In typical embodiments, one or two loop antennas are employed in combination with a reference antenna (typically a dipole antenna), and a direct-phase comparison of the signal from the antennas is performed, which is significantly unlike the existing art.

Although the existing art uses two loop antennas and a reference antenna, the way the existing art uses the antennas to determine the direction of the signal are significantly different than what is discussed in this disclosure. Generally speaking, existing systems in the art make use of the summing and/or difference of the loop antenna signal in the determination of the incident RF angle. It requires that the loop antenna have an amplitude component that is dependent on angle of the incident RF signal so that the summation of the loop antenna's signal with the reference antenna's signal will create a composite signal that has a composite amplitude and a composite phase of the two antennas. It also requires that the phase of each of the loop antennas remains relatively constant but different than the phase of the other loop antenna over a defined incident angle or rotation. Typically, this limits the design to small loop antennas with the preference that the antennas be near each other.

The difference between the new systems described in this disclosure and the existing art for dual-loop antennas is that the new systems described herein do not use the summing and difference of the RF signal, but instead use a direct-phase comparison technique. Direct-phase comparison requires that the phase of each of the antennas changes when the incident RF angle changes, either abruptly or continuously. The new systems presented herein allow the use of both small-loop and medium-loop antennas, thus allowing greater design flexibility. In the direct-phase comparison technique, the antennas are not required to have a specific gain pattern.

Often, existing systems in the art require that the loop antennas be orthogonal to each other. The new systems described in this disclosure allow the antennas to be at almost any angle to each other, which once again facilitates greater design flexibility and allows for more-compact physical configurations. Because the loop antenna-gain pattern is not an issue in the present disclosure, the new systems presented herein allow for the use of one or more medium-loop antennas, discussed infra. Generally speaking, a medium-loop antenna has better sensitivity to the RF signal than a small-loop antenna, which in turn allows for a greater signal-receiving range.

Moreover, a medium-loop phase response is not sharp like that associated with a small-loop antenna (with the phase response being zero or 180 degrees). In addition, unlike a one-wavelength, large-loop antenna (which has little or no phase response), the medium-loop phase response is soft and varies based on the incident RF angle. Several embodiments of the new systems described herein takes advantage of the medium-loop-antenna characteristics in order to more-effectively determine the incident RF signal.

Another distinction and advantage with the new systems described herein, is that if one of the two loop antennas is wound in the reverse direction compared to other loop antenna, a third phase signal between the two loop antenna can be developed which changes at twice the rate of the incident RF angle. The resultant double-frequency output can be used to get a more accurate directional accuracy.

Some of the embodiments of the new systems described herein can use only two antennas (a single loop antenna (small or medium in electrical size) and a reference antenna), yet still be effective. Although such a system of a single loop and a reference antenna will not allow the system to directly calculate the direction of the incident RF angle, the user is still able to determine exactly the direction of the RF signal by rotating the portable apparatus according to the right/left direction indicator on the apparatus. The advantage of using only a single loop antenna and a reference antenna is that it can be made smaller and simpler than a dual loop antenna with a reference antenna.

The embodiments of the apparatus described herein can be configured for fixed-mounted configurations, as well as portable configurations. In embodiments where it is necessary for the antennas to be rotated to determine the direction of the RF signal source, the antennas can be fixed-mounted on a rotatable platform so that the antennas can be rotated together. Rotating the antennas for such fixed-mounted configurations is the equivalent to rotating the apparatus in the portable configurations.

### Terminology

The terms and phrases as indicated in quotes (“ ”) in this section are intended to have the meaning ascribed to them in this Terminology section applied to them throughout this document, including the claims, unless clearly indicated otherwise in context. Further, as applicable, the stated definitions are to apply, regardless of the word or phrase's case, to the singular and plural variations of the defined word or phrase.

The term “or”, as used in this specification and the appended claims, is not meant to be exclusive; rather, the term is inclusive, meaning “either or both”.

References in the specification to “one embodiment”, “an embodiment”, “a preferred embodiment”, “an alternative embodiment”, “a variation”, “one variation”, and similar phrases mean that a particular feature, structure, or characteristic described in connection with the embodiment is included in at least an embodiment of the invention. The appearances of the phrase “in one embodiment” and/or “in one variation” in various places in the specification are not necessarily all meant to refer to the same embodiment.

The term “couple” or “coupled”, as used in this specification and the appended claims, refers to either an indirect or a direct connection between the identified elements, components, or objects. Often the manner of the coupling will be related specifically to the manner in which the two coupled elements interact.

The term “removable”, “removably coupled”, “readily removable”, “readily detachable”, and similar terms, as used in this patent application specification (including the claims and drawings), refer to structures that can be uncoupled from an adjoining structure with relative ease (i.e., non-destructively and without a complicated or time-consuming process) and that can also be readily reattached or coupled to the previously adjoining structure.

Directional and/or relational terms such as, but not limited to, “left”, “right”, “nadir”, “apex”, “top”, “bottom”, “vertical”, “horizontal”, “back”, “front”, and “lateral” are relative to each other, are dependent on the specific orientation of an applicable element or article, are used accordingly to aid in the description of the various embodiments, and are not necessarily intended to be construed as limiting.

As applicable, the terms “about” or “generally”, as used herein unless otherwise indicated, means a margin of +−20%. Also, as applicable, the term “substantially” as used herein unless otherwise indicated means a margin of +−10%. It is to be appreciated that not all uses of the above terms are quantifiable such that the referenced ranges can be applied.

The term “small-loop antenna”, as used in this specification and the appended claims, refers generally to an antenna consisting of a “loop” of wire or other conductor (though the shape of the loop need not be round or circular), with its ends connected to a two-wire transmission line for signal transmission. Generally speaking, the size of a “small-loop antenna” has a maximum length of the “loop” of the antenna (that is, the total length of the conductor in the loop) of 0.25λ (wavelength), though most “small-loop” directional-receiving antennas have a maximum length of 0.1λ. For the purposes of this patent application, a “small-loop antenna” has a maximum length of 0.1λ. A “small-loop antenna” responds primarily to magnetic fields, and almost not at all to electric fields.

The term “large-loop antenna”, as used in this specification and the appended claims, refers generally to an antenna consisting of a “loop” of wire or other conductor (though the shape of the loop need not be round or circular), with its ends connected to a two-wire transmission line for signal transmission. The size of a “large-loop antenna” has a total length of the “loop” of the antenna (that is, the total length of the conductor in the loop) of at least 1λ (wavelength). A “large-loop antenna” responds primarily to electric fields, and almost not at all to magnetic fields. A “large-loop antenna” generally exhibits a higher gain than a “small-loop antenna” or a “medium-loop antenna”, as the gain of this type of antenna is directly proportional to the area enclosed by the loop. “Large-loop antennas” usually have their strongest signal response within the plane of the loop, and the nulls are in the axis perpendicular to the plane of the loop.

The term “medium-loop antenna”, as used in this specification and the appended claims, refers generally to an antenna consisting of a “loop” of wire or other conductor (though the shape of the loop need be round or circular), with its ends connected to a two-wire transmission line for signal transmission. The electrical size of a “medium-loop antenna” falls between that of a “small-loop antenna” and a “large-loop antenna”, and as a result is responsive to both magnetic and electric fields. “Medium-loop antennas” are adapted to generate a phase response to received electric and/or magnetic waves to approximate a sine wave, or at least exhibit a gradual phase change.

The term “windings”, as used in conjunction with loop antennas within this specification and the appended claims, refers to additional turns of antenna conductor that are employed to increase the gain and/or aperture of a given loop antenna, which generally enhances the effectiveness of a loop antenna that is used in a radio-signal directional finding application.

The term “moved”, as used in reference to manipulating the position of a radio-signal-source direction-finding receiver apparatus within this specification and the appended claims, refers to the rotation of the apparatus along a horizontal plane and/or the pitch of the apparatus along the vertical plane in order to optimize radio-signal source direction detection.

The term “multiples”, as used within this specification and the appended claims, refers to a unique calculation of phase differences between the different antennas that comprise a radio-signal-source direction-finding receiver. For example, the output values of a first loop antenna is multiplied with the output value of a reference antenna. A compensating phase-shifting factor (such as 90 degrees) is added to one of the signals to center the range of the phase comparison.

The term “unified bearing angle signal”, or similar terms, as used within this specification and the appended claims, refers to the use of all of the multiples generated by the system to determine the originating direction of a detected radio signal without ambiguity.

### Detailed Discussion of the Phase Characteristics of Small-Loop, Medium-Loop, and Large-Loop Antennas

Loop antennas are often categorized by the total length of the conductor in the loop. A small-loop antenna, typically defined as having the total loop conductor length of less than or equal to 0.1λ (wavelength), responds primarily to the magnetic field. In comparison, a large-loop antenna, with the total loop conductor length of about 1λ, responds primarily to the electric fields.

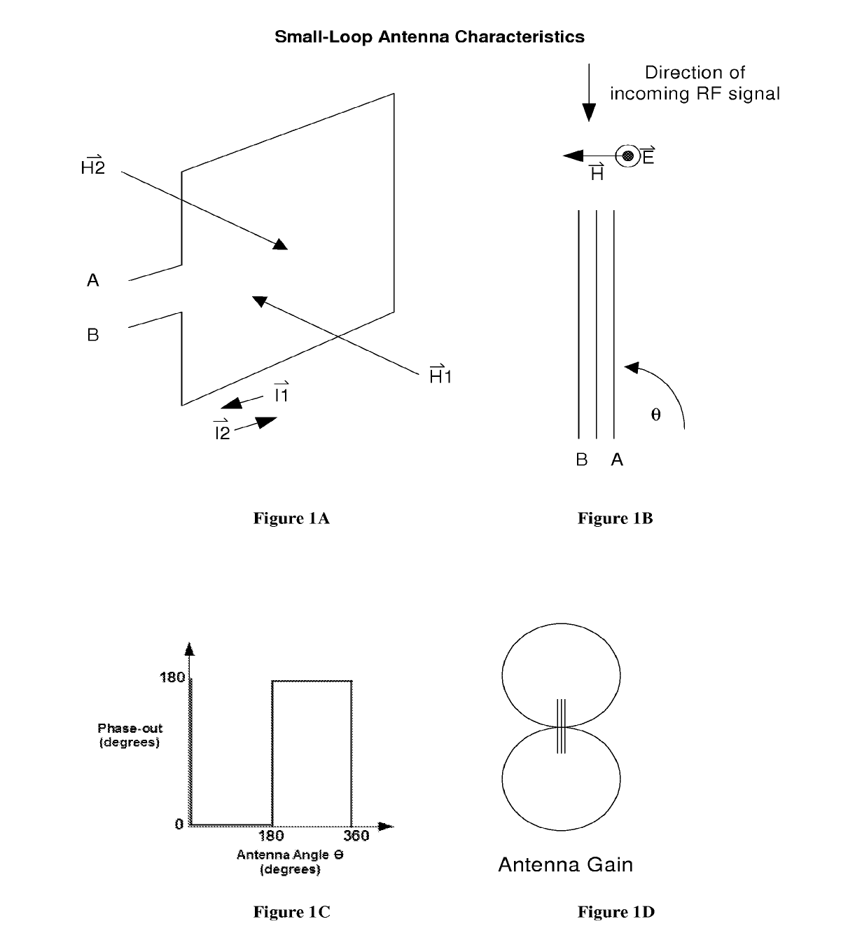

Refer to FIGS. 1A-1D, which combine to show the typical characteristics for a small-loop antenna. FIG. 1A shows that as the magnetic field (generically referred to as H̅) enters from a first side H̅1, the current flows in one direction Ī1, and when the magnetic field enters from a second side H̅2, the resultant current flows in the opposite direction Ī2. FIG. 1B depicts the top view of the small-loop antenna, with the antenna rotated by angle θ, relative to the horizontal axis. FIG. 1C shows the phase response of the small-loop antenna when the small-loop antenna is rotated relative to the incoming RF signal. Given that the RF signal is coming from the top and θ is the angle of the antenna relative to the horizontal axis as shown in the drawings, the phase response is constant when θ is greater than 0 and less than 180 degrees. The phase from the antenna will flip 180 degrees when the angle is greater than 180 degrees and less than 360 degrees. The phase shift is sharp for a small-loop antenna since the magnetic field enters the antenna from either one side or the other and its response to the electric field is minimal. Hence, the phase response of a small-loop antenna is either 0 or 180 degrees. Finally, FIG. 1D shows the plot of a typical small-loop antenna gain response.

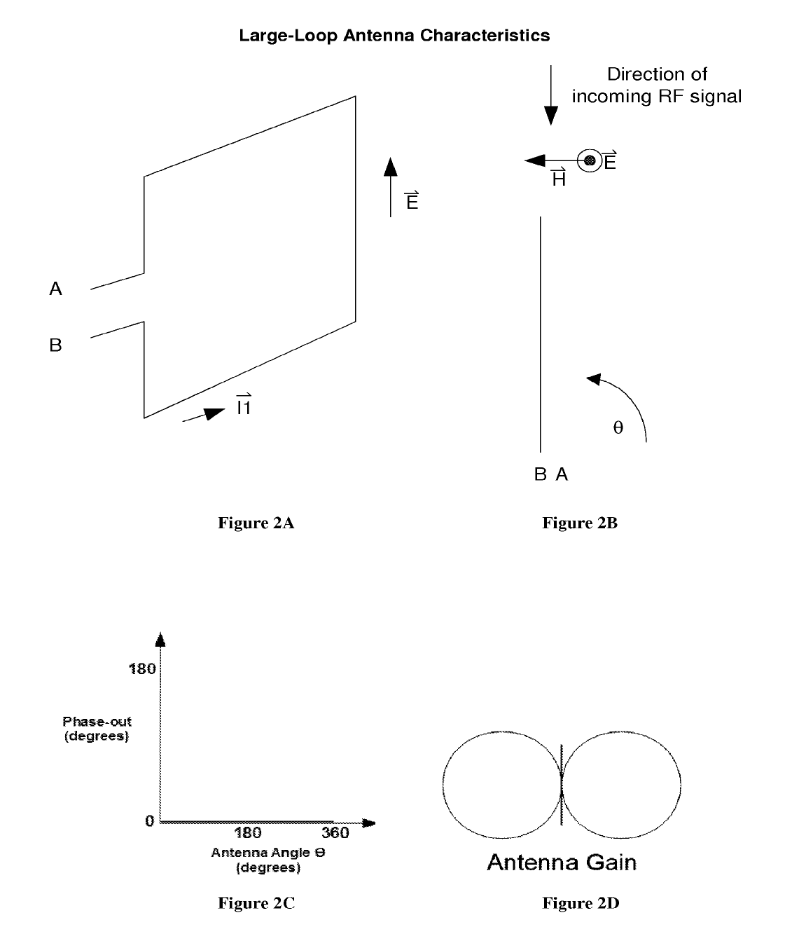

Refer to FIGS. 2A-2D, which combine to show the typical characteristics for a large-loop, one-wavelength (1λ) antenna. FIG. 2A shows that the antenna response is due primarily to the electric field Ē. The large-loop antenna phase response does not change when the antenna is rotated relative to the incoming RF signal; therefore, when θ varies from 0 to 360 degrees, the phase of the antenna is a constant, as shown in FIGS. 2B and 2C. Finally, FIG. 2D shows the antenna gain response plot of a typical large-loop antenna. Note that the gain response of the large-loop antenna is rotated 90 degrees from the gain response of the small-loop antenna.

In one exemplary embodiment, at least one loop antenna is used, wherein the loop antenna(s) is(are) electrically smaller than a large-loop antenna; that is the loop antenna(s) is(are) either a small-loop antenna or a medium-loop antenna. A medium-loop antenna is a loop antenna that is electrically sized between a small-loop antenna and a large-loop antenna, and as a result is responsive to both the magnetic and electric fields. By using an antenna that responds to both the magnetic and electric fields, the antenna will generate a phase response that approximates a sine wave, and has a gradual phase change, when the antenna is rotated relative to the angle of incident RF signal. Instead of having an abrupt phase change, as in the case of a small-loop antenna, or no phase change, as in the case of a large-loop antenna, the medium-loop antenna's gradual phase change can be used to increase the resolution in determining the direction of the received RF signal. To create such a medium-loop antenna, the total conductor length is increased from a small-loop antenna until the desired response is obtained. The number of turns, the gap between the turns, and the size of the loop will also affect the characteristic of the resultant medium-loop antenna. The ratio of the antenna's magnetic-field response and electric-field response determines the phase response of the overall antenna that incorporates at least one medium-loop antenna.

The characteristic response of a small-loop antenna can be approximated by the formulas:

|sin θ|sin(ωt),0°<θ<180° (Formula 1)

−|sin θ|sin(ωt),180°<θ<360° (Formula 2)
where:
   θ is the RF incident angle on the antenna
   ω is the signal/driving frequency
t is time in seconds

The characteristic response of a one-wavelength (1λ), large-loop antenna can be approximated by the formula:

|cos θ|cos(ωt), for all θ (Formula 3)
where:
   θ is the RF incident angle on the antenna
   ω is the signal/driving frequency
   t is time in seconds

However, the characteristic response of a medium-loop antenna can be approximated as the summation of the large-loop and small-loop antenna responses, approximated by the formulas:

|A sin θ|sin(ωt)+|(1−A)cos θ|cos(ωt),0°<θ<180°,0≦A≦1 (Formula 4)

−|A sin θ|sin(ωt)+|(1−A)cos θ|cos(ωt),180°<θ<360°,0≦A≦1 (Formula 5)
where:
   A is a factor that describes the medium-loop antenna response to the magnetic field versus the electric field
   θ is the RF incident angle on the antenna
   ω is the signal/driving frequency
   t is time in seconds

Using trigonometric identities, the formula for the medium-loop antenna above can be represented by the following formulas:

$$\begin{matrix}( \sqrt{{( A sin θ )}^{2} + {( 1 - A )}^{2} {cos}^{2} θ} ) ( sin ω t + ϕ ) & ( Formula 6 ) \\ ϕ = {sin}^{- 1} ( \frac{\vert ( 1 - a ) cos θ \vert}{\sqrt{{( A sin θ )}^{2} + {( 1 - A )}^{2} {cos}^{2} θ}} ) , \\ 0 ° < θ < 180 ° & ( Formula 7 ) \\ ϕ = π - {sin}^{- 1} ( \frac{\vert ( 1 - A ) cos θ \vert}{\sqrt{{( A sin θ )}^{2} + {( 1 - A )}^{2} {cos}^{2} θ}} ) , \\ 180 ° < θ < 360 ° & ( Formula 8 )\end{matrix}$$

where:
   A is a factor that describes the medium-loop antenna response to the magnetic field versus the electric field
   θ is the RF incident angle on the antenna
   ω is the signal/driving frequency
   φ is the phase response of the medium loop antenna
   t is time in seconds

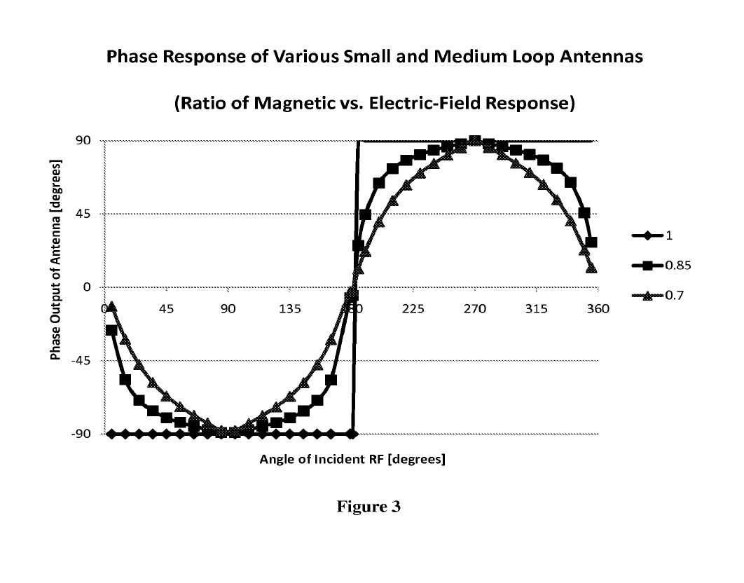

An A of 1 means that the antenna acts like a small-loop antenna and responds only to the magnetic component of the incident RF field, and an Λ of 0 means the antenna responds like a 1-wavelength, large-loop antenna. FIG. 3 shows the relative phase response of the loop antenna for a few values of A: 1, 0.85, and 0.7. An A of 0.85 means that 85 percent of the signal is in response to the magnetic field and that 15 percent of the signal is in response to the electric field. The phase response can be adjusted to be approximately that of a sine wave, sharper or less sharp, depending on the need.

Another advantage of incorporating a medium-loop antenna in a direction-finding receiver is that the amplitude null typically realized found in the small-loop antenna is reduced. Consequently, there is not a loss of signal at the null for medium-loop antennas.

The amplitude response of a medium-loop antenna is represented by the expression \sqrt{(A sin θ)²(1−A)² cos² θ} of the Formula 6, supra.

### First Embodiment

### A Dual-Antenna RF-Direction-Finding Receiver

This embodiment is directed generally to a direction-finding receiver that determines the originating direction of the received radio-signal source, which in some variations is adapted to be readily portable. In typical examples, a single loop antenna is employed in combination with a reference antenna (typically a dipole antenna), and a direct-phase comparison of the signal from the antennas is performed.

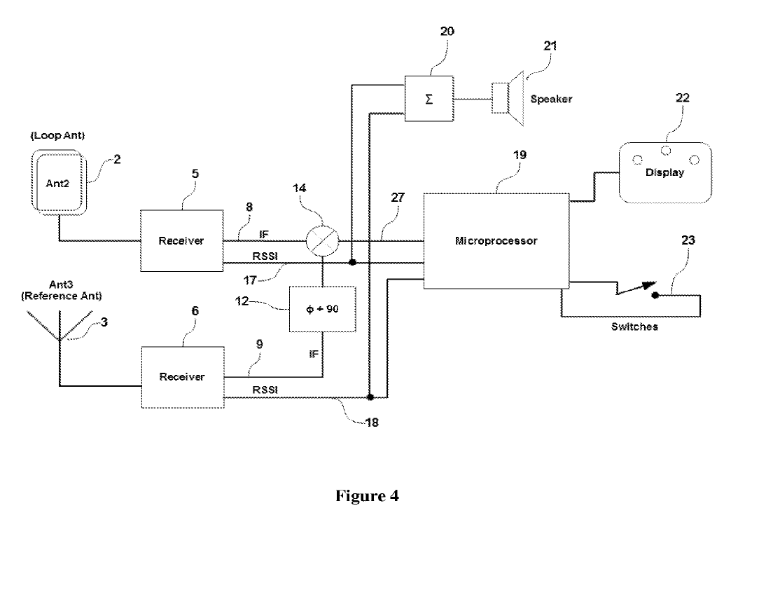

Refer to FIG. 4, which depicts a basic circuit block diagram for one embodiment for such dual-antenna design. In many variations, the phase characteristics of a small-loop antenna or medium-loop antenna 2 is used in conjunction with a reference antenna 3 in order to determine the originating direction of a received RF signal. The loop antenna phase signal 8 is compared with the reference antenna phase signal 9. The phase output of the apparatus in FIG. 4 is the same as that shown in FIG. 3. When the phase is greater than zero, the directional indicator display 22 will prompt the user to rotate the device in a first direction. Conversely, when the phase is less than zero, the directional indicator display 22 will prompt the user to rotate the device in the opposite direction. The right or left directional indicator on the display 22 is determined by the phase output from the microprocessor 19.

There are two zero-phase cross-over points for the device depicted in the example in FIG. 4: One is directly in front of the apparatus, defined here as zero degrees (or as the “zero-degree position”), and the second zero-phase cross-over point is located at the opposite direction of the signal, defined here as 180 degrees (or as the “180-degree position”). When the user is pointing the apparatus represented in FIG. 4 in the exact opposite direction (180 degrees) and rotates the apparatus slightly to the right or left, the directional indicator display 22 will indicate a direction away from the 180-degree position. Accordingly, the user will know that the direction is correct when the user rotates to the right or left, causing the right and left indicators on the display 22 to point the user back to the center (as opposed to away).

The two radio signal strength indicators (RSSIs) 17, 18 from the receivers 5, 6, respectively, are fed into and digitized by the microprocessor. The signal strength is put on the display 22 where a user can use the signal strength to estimate the distance of the receiver to the source.

In some configurations, by using the antenna-gain characteristics of the loop antenna 2, or by using the gain characteristic of the reference antenna 3 when it interacts with the loop antenna 2, or by using the gain characteristic of the loop antenna 2 when it interacts with the reference antenna 3, a user can use the signal strength indicator 22 as an additional source of information to determine the RF source direction and distance to the RF source as the apparatus position is changed. The microprocessor 19 may also use the antenna-gain characteristic to improve the accuracy of the directional indicator display 22.

In applications when the RF signal is amplitude-modulated with an audio signal, the receivers' 5, 6 radio-signal strength indicator signals 17, 18 are demodulated and amplified with an audio amplifier 20. The audio signal is then used to modulate speaker 21 in order to give a user an audio indication of the RF signal.

In some variations, the RSSI signals 17, 18 are fed and summed in an audio amplifier 20 and then to a speaker 21, in order to give a user an audio indication as to the RF source direction as the apparatus position is changed.

Even though this embodiment uses only two antennas (a single loop antenna 2 (small or medium in size) and a reference antenna 3), it can yet still be effective. Generally, such a system using only a single loop and a reference antenna will not allow the system to directly calculate the direction of the incident RF angle; however, the user is still able to determine exactly the direction of the RF signal by rotating the portable apparatus according to the right/left direction indicator on the apparatus. The advantage of using only a single loop antenna and a reference antenna is that it can be made smaller and simpler than a three-antenna system that has two loop antennas and a reference antenna.

### Second Embodiment

### A Three-Antenna RF-Direction-Finding Receiver

This embodiment is directed generally to a direction-finding receiver that determines the originating direction of the received radio-signal source, which in some variations is adapted to be readily portable. In typical examples, two medium-loop antennas are employed in combination with a reference antenna (typically a dipole antenna), and a direct-phase comparison of the signal from the antennas is performed.

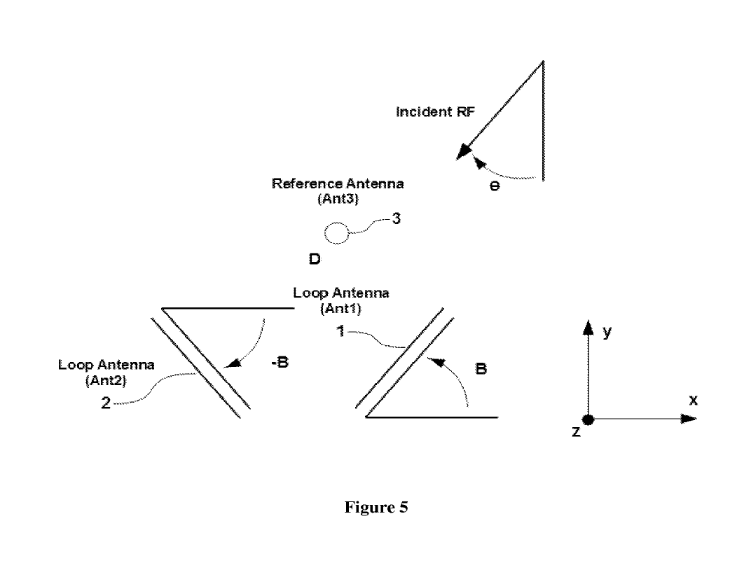

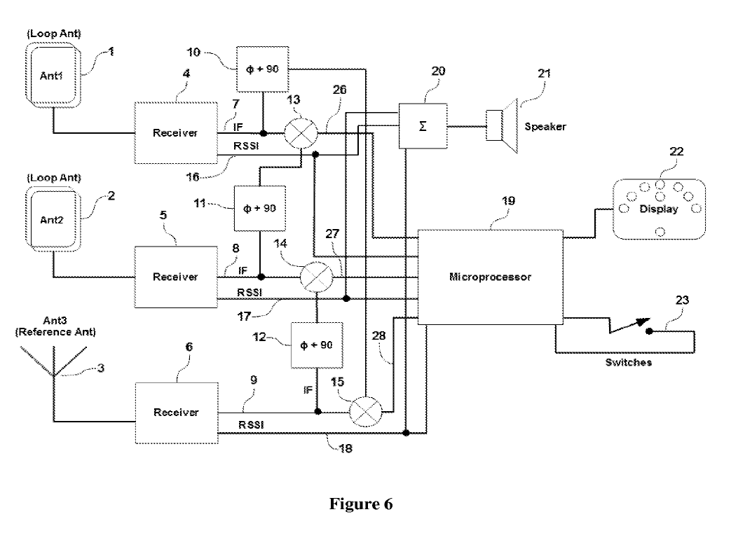

In many variations, the phase characteristics of two medium-loop antennas are used in conjunction with a reference antenna in order to determine the originating direction of a received RF signal. The full implementation employs two medium-loop antennas and a reference antenna, as shown in FIG. 5, from a top-view perspective. The three antennas (a first loop antenna (Ant2) 2, a second loop antenna (Ant1) 1, and a dipole reference antenna (Ant3) 3) are arranged with a distance between them much less than one wavelength (1λ). Ant2 2 has reverse-wound windings, as compared to the windings in Ant1 1. Ant3's 3 phase response does not change relative to direction of the incoming RF signal. In variations of this embodiment, the reference antenna (Ant3) 3 can be a dipole type, a monopole type, a helical type, or any other type of antenna to be effective. The windings of Ant1 1 and Ant2 2 are in the z-axis, and if a dipole or similar antenna is used for Ant3 3, then Ant3 3 would be oriented in the z-axis as shown in FIG. 5. Moreover, the two loop antennas 1, 2 are typically placed at equal, but opposite, angles relative to the reference antenna 3, though this is not necessarily a requirement as long as the loop antennas 1, 2 are not parallel to each other. If the distance between the antennas 1, 2, 3 is not short relative to the RF signal wavelength, then the phase will need to be adjusted due to the fact that RF signal will arrive at different times at the antennas depending on the direction of the incident RF signal. Similarly, an unsymmetrical antenna orientation would result in a phase comparator output (see FIGS. 6; 13, 14, 15) that has a phase shift relative to the other antennas; however, such an offset can be compensated in a system that calculates the direction of the RF signal as well.

The angle of the two loop antennas 1, 2, relative to the incoming RF signal, determines the phase of the RF signal arriving at a given antenna. By comparing the phase difference between the two loop antennas 1, 2 to the reference antenna 3, two vectors are generated that determine the direction of the transmitting signal without the 180-degree ambiguity that might be realized using existing-art systems. By comparing the phase difference between the two loop antennas 1, 2, a double-frequency phase response is obtained, which can be used to obtain more precise directional indication 22 (see FIGS. 6; 22). With three antennas 1, 2, 3, it is possible to determine the precise direction of the incident RF signal with no directional ambiguity.

Assuming: (1) a symmetrical loop-antenna orientation angle relative to the x-axis, (2) the loop winding for Ant2 2 is reversed as compared to the loop winding for Ant1 1, and (3) θ is the angle of the incident RF, then the equations used to describe the orientations of the three antennas 1, 2, 3 are:

Ant1=sin(ωt+θ+B) (Formula 9)

Ant2=sin(ωt−(θ−B)) (Formula 10)

Ant3=sin(ωt) (Formula 11)
where:
   θ is the RF incident angle on the antenna
   B is angle of the given antenna relative to the horizontal axis
   ω is the signal/driving frequency
   t is time in seconds

Using the trigonometric multiplication identity,

$$sin u sin v = \frac{1}{2} [ cos ( u - v ) - cos ( u + v ) ] ,$$

as a phase-difference calculation means or algorithm, the resulting phase comparator outputs (see FIGS. 6; 13, 14, 15) are shown in Table 1 below. The second cosine term with 2 ωt (in the fourth column) is filtered out in the circuit, so only the first term in the fourth column is relevant.

TABLE 1
Phase Comparator Output of a Three-Antenna System
With Windings of the Loop Antennas Reversed from Each Other

| PHASE | u | V | sinusinv |
|---|---|---|---|
| Ant1*(Ant2 + 90°) comparator 13 | ωt + θ + B | ωt − (θ − B) + 90° | $= \frac{1}{2} [ cos ( 2 θ - {90}^{∘} ) - cos ( 2 ωt + 2 B + {90}^{∘} ) ]$ |
| Ant2*(Ant3 + 90°) comparator 14 | ωt − (θ − B) | ωt + 90° | $= \frac{1}{2} [ cos ( - θ + B - {90}^{∘} ) - cos ( 2 ωt - θ + B + {90}^{∘} ) ]$ |
| Ant3*(Ant1 + 90°) comparator 15 | ωt | ωt + θ + B + 90° | $= \frac{1}{2} [ cos ( - θ - B - {90}^{∘} ) - cos ( 2 ωt + θ + B + {90}^{∘} ) ]$ |

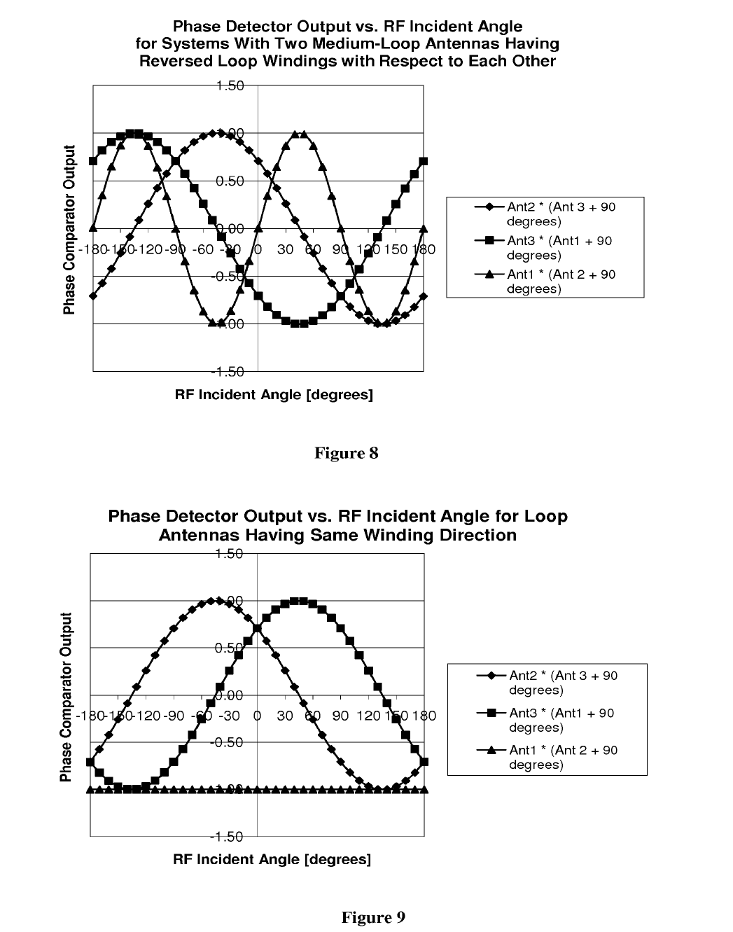

FIG. 8 plots the phase comparator outputs (FIGS. 6; 13, 14, and 15) with angle B in FIG. 5 being 45 degrees, relative to the horizontal axis. The incident RF angle is easily determined by the relationship of the phase signals Ant2*(Ant3+90 degrees) and Ant3*(Ant1+90 degrees). Of particular note, the phase output Ant1*(Ant2+90 degrees) has a double-frequency response relative to the incident RF, or twice the sensitivity relative to the other two phase signals as a result of the reversed windings between the two loop antennas. Consequently, this signal is used to more accurately determine the direction of the incident RF signal, since it is twice as sensitive to angle changes as compared to the other two signals.

Referring to FIG. 6, which shows an embodiment of a block diagram of the electronics used to determine the direction of the incident RF. An RF receiver 4, 5, 6 and phase comparator 13, 14, 15 is used for each antenna. The receiver selectively receives on a predetermined frequency to match the transmitter frequency. The phase comparators 13, 14, compare the phase differences between the different antennas: Ant1*(Ant2+90 degrees), which is the third multiple of the bearing angle; Ant2*(Ant3+90 degrees), which is the first multiple of the bearing angle; and Ant3*(Ant1+90 degrees), which is the second multiple of the bearing angle. Ninety-degree phase shifters 10, 11, 12 are used to center the range of phase comparison for phase detectors which work by multiplying the two inputs; however, such phase shifting is not necessarily required for all implementations in variations of this embodiment. A microprocessor 19 accepts the first multiple of the bearing angle 27 and the second multiple of the bearing angle 28 as inputs, and calculates the bearing angle signal which represents the direction of the incident RF and shows the direction on a display 22. The microprocessor improves the resolution of the calculation by incorporating the third multiple of the bearing angle 26.

The three radio signal strength indicators (RSSIs) 16, 17, 18 are fed into and digitized by the microprocessor 19. The signal strength is put on the display 22 where a user can use the signal strength to estimate the distance of the receiver to the source.

In some configurations, by using the antenna-gain characteristics of one or both of the loop antennas 1, 2, or by using the gain characteristic of the reference antenna 3 when it interacts with one or both of the loop antennas 1, 2, or by using the gain characteristic of one or both of the loop antennas 1, 2 when they interact with each other or with the reference antenna 3, a user can use the signal strength indicator 22 as an additional source of information to determine the RF source direction and distance to the RF source as the apparatus position is changed. The microprocessor 19 may also use the antenna-gain characteristic to improve the accuracy of the directional indicator display 22.

In applications when the RF signal is amplitude modulated with an audio signal, the receivers' 4, 5, 6 radio-signal strength indicator signals (RSSIs) 16, 17, 18 are summed, demodulated, and amplified with an audio amplifier 20. The audio signal is then used to modulate speaker 21 in order to give the user an audio indication of the RF signal.

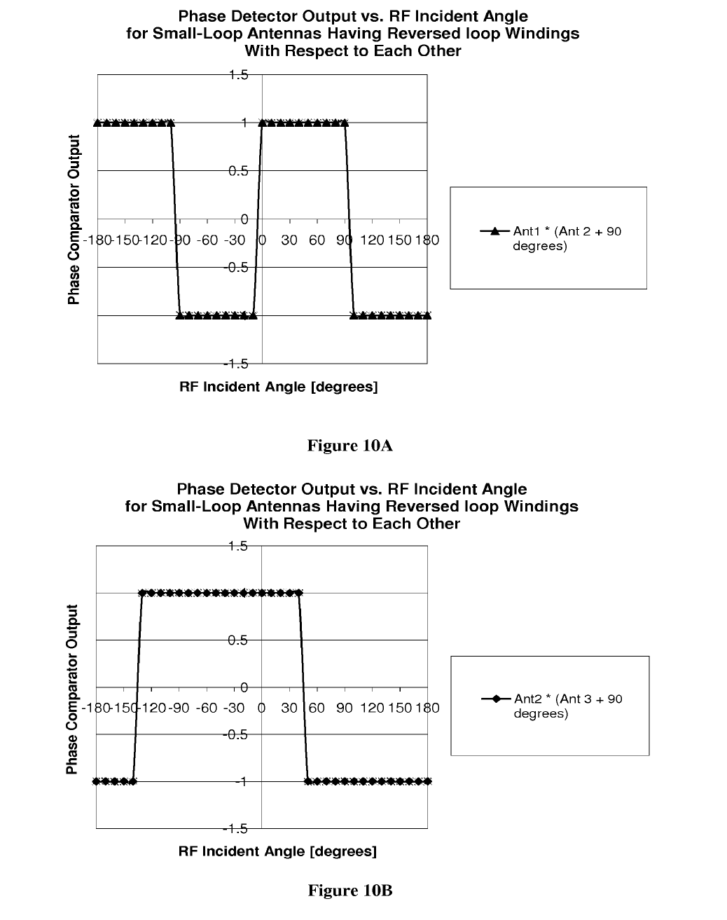

In an embodiment, if the windings of the first loop antenna (Ant2) 2 are not reversed relative to the windings of the second loop antenna (Ant1) 1, then the phase difference between Ant1 and Ant2 becomes a constant and, as a result, the double-frequency response relative to the incident RF angle, θ, is not present. Table 2 shows the resulting phase-comparator outputs for a system where Ant1 1 and Ant2 2 windings are wound in the same direction, and FIG. 9 depicts a plot of the phase-comparator output for this system.

TABLE 2
Phase Comparator Output of a Three-Antenna System With Windings
of the Loop Antennas Wound the Same Direction Relative to Each Other

| PHASE | u | V | sinusinv |
|---|---|---|---|
| Ant1*(Ant2 + 90°) Comparator 13 | ωt + θ + B | ωt + θ − B + 90° | $= \frac{1}{2} [ cos ( 2 B + {90}^{∘} ) - cos ( 2 ωt + 2 B - {90}^{∘} ) ]$ |
| Ant2*(Ant3 + 90°) Comparator 14 | ωt + (θ − B) | ωt + 90° | $= \frac{1}{2} [ cos ( θ - B + {90}^{∘} ) - cos ( 2 ωt + θ - B + {90}^{∘} ) ]$ |
| Ant3*(Ant1 + 90°) Comparator 15 | ωt | ωt + θ + B + 90° | $= \frac{1}{2} [ cos ( θ - B + {90}^{∘} ) - cos ( 2 ωt + θ + B + {90}^{∘} ) ]$ |

### Third Embodiment

### A Three-Antenna RF-Direction-Finding Receiver

This embodiment is directed generally to a direction-finding receiver that determines the originating direction of the received radio-signal source, which in some variations is adapted to be readily portable; however, unlike the Second Embodiment, described supra, the double-frequency phase response (and resultant increase in accuracy) is either not needed, or if needed, then can be calculated by a microprocessor in the receiver.

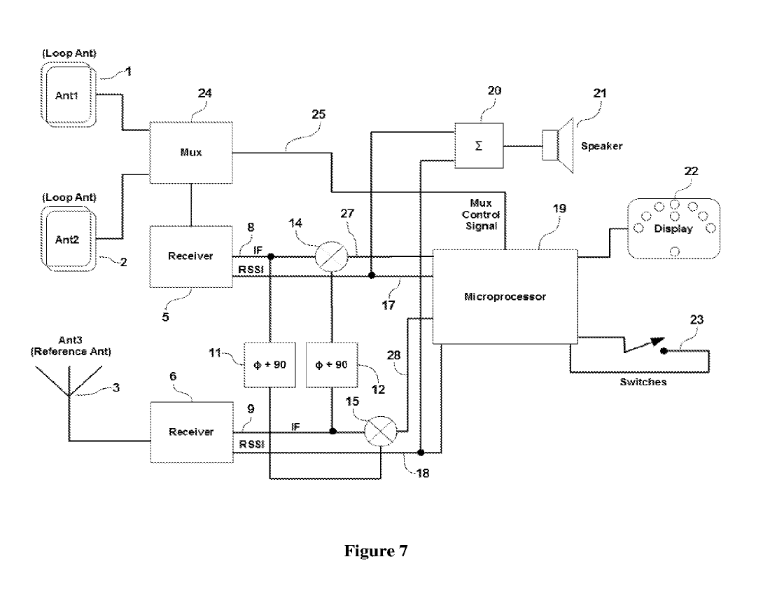

In typical examples, two medium-loop antennas are employed in combination with a reference antenna (typically a dipole antenna), and a direct-phase comparison of the signal from the antennas is performed. In many variations, the phase characteristics of two medium-loop antennas are used in conjunction with a reference antenna in order to determine the originating direction of a received RF signal. FIG. 7 depicts one embodiment of an alternate electronics arrangement, wherein double-frequency phase response and resultant increase in accuracy in bearing are not needed, or is calculated in the microprocessor 19 from the Ant3*(Ant12+90 degrees) and Ant2*(Ant3+90 degrees) signals. In this case, a multiplexor 24 is used to receive the outputs of both loop antennas 1, 2 and selects which signal is routed to the receiver 5, depending on the multiplexor control signal 25 coming from the microprocessor 19. As can also be observed, an Ant1*Ant2 phase comparator is not utilized in this embodiment. In addition, in some variations of this embodiment, two 90-degree phase shifters 11, 12 are used as inputs to their respective comparators 15, 14. However, in still other variations, only one phase shifter 12 is used as an input to its respective comparator 14, while the other phase shifter 11 can be omitted and the microprocessor 19 can generate the same information. The main idea behind these alternate configurations, such as that depicted in FIG. 7, is to simply reduce the receiver circuit size by roughly one-third, while still substantially maintaining the functionality of the receiver circuit depicted in FIG. 6.

In FIG. 6, each antenna has its own RF receiver 4, 5, 6. In FIG. 7, the loop antenna 1, 2 signals are multiplexed using an analog RF switch 24, 25 into a single receiver 5 after which it is compared 14, 15 against the reference antenna 3. Note that in this configuration it is not possible to directly multiply Ant1 1 *Ant2 2 in the circuit; however, the result can be calculated in the microprocessor 19 using the two other signals that are being compared, Ant2 2 *(Ant3 3+90 degrees) and Ant3 3*(Ant1 1+90 degrees).

Because the Ant1 1 and Ant2 2 signals are compared to a reference signal, Ant3 3, it is possible to back out the phases of Ant1 1 and Ant2 2. Once the phases of Ant1 1 and Ant2 2 are known, it is possible to calculate Ant1 1 *(Ant2 2+90 degrees) in the microprocessor 19. In such a case, the third signal is a microprocessor 19 internally-generated third multiple, which can be used in the same way as the third multiple generated by the phase comparator 13 in FIG. 6.

### Fourth Embodiment

### A Three-Antenna RF-Direction-Finding Receiver Using Small-Loop Antennas

This embodiment is directed generally to a direction-finding receiver that determines the originating direction of the received radio-signal source, which in some variations is adapted to be readily portable, similar to those disclosed in the Second and Third Embodiments, described supra. However, unlike the Second and Third Embodiments, the system of this embodiment uses only small-loop antennas for its loop antennas.

When only small loop antennas are used in a three-antenna system, a loss in resolution will be the result, since the phase response of the small loop antennas is either zero degrees or 180 degrees as shown in FIG. 1C. Even so, such a system can still be used to determine the direction of the signal without ambiguity, while also presenting the advantage of having a more-compact and portable physical design. For a system with two small-loop antennas, with each of those small-loop antennas having windings reversed from each other, a third phase signal between the two loop antennas can be developed which changes at twice the rate of the incident RF angle. The resultant double-frequency output can be used to get a more accurate directional accuracy.

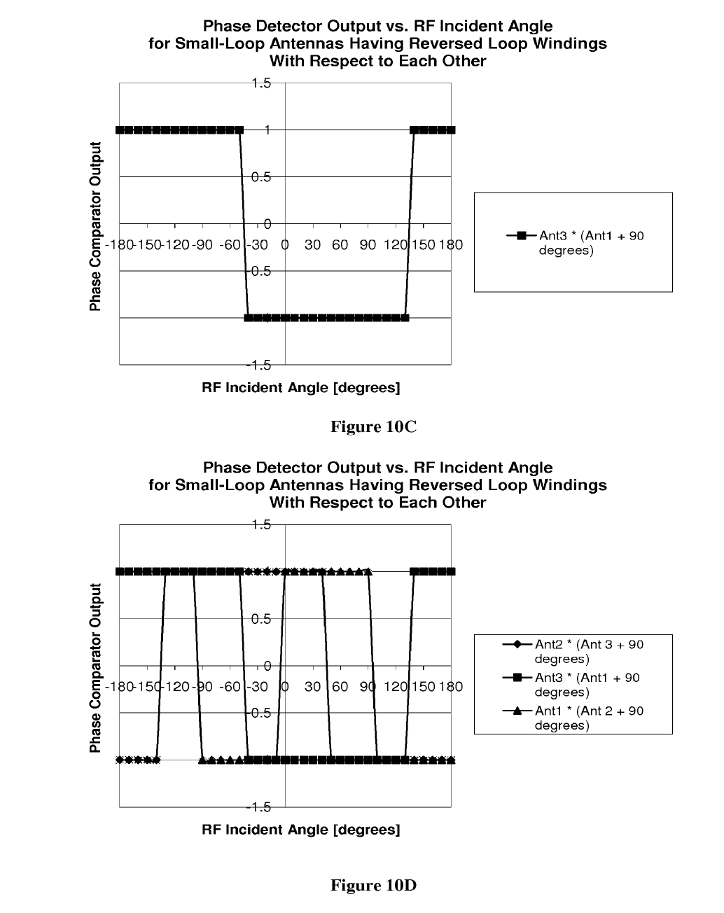

See FIGS. 10A-10D, which shows graphs of typical phase-detector outputs versus the incident RF angle for a system of this type. In particular, FIG. 10D shows the relationship between the three different phase-comparator outputs on a single graph. In this case, the resolution of the direction is only 45 degrees. By using the abrupt phase transition, it is possible to determine the precise direction of the source of the incident RF signal. Conversely, if the windings of the two small-loop antennas are not reversed, the phase comparison of Ant1*(Ant2+90 degrees) becomes a constant and thus the third multiple would not be useful for the determination of the incident RF angle.

### Fifth Embodiment

### A Multi-Antenna RF-Direction-Finding Receiver

This embodiment is directed generally to a direction-finding receiver that determines the originating direction of the received radio-signal source, which in some variations is adapted to be readily portable. Refer to FIG. 4. In this embodiment, the apparatus is comprised of:
a first loop antenna 2 adapted to be responsive to a predetermined radio signal, the first loop antenna 2 capable of supplying a first loop output signal upon interaction with a predetermined radio signal, wherein the first loop antenna 2 is adapted such that the phase of the first loop output signal varies as the first loop antenna 2 is moved in a plane intersecting the predetermined radio signal;
a reference antenna 3 adapted to be responsive to the predetermined radio signal, the reference antenna 3 capable of supplying a reference output signal upon interaction with the predetermined radio signal, wherein the reference antenna 3 is adapted such that the phase of the reference output signal does not vary substantially as the reference antenna 3 is moved in the plane intersecting the predetermined radio signal; and
a first phase comparator 14 directly responsive to the phase difference between the first loop output signal 8 and the reference output signal 9, wherein the first phase comparator 14 is adapted to generate a first multiple of the bearing angle from the apparatus to the source of the predetermined radio signal.

This embodiment can be further enhanced wherein the first loop antenna 2 is of an electrical size selected from the group consisting of small-loop antennas and medium-loop antennas.

This embodiment can be enhanced by further comprising right and left directional indicators 22, wherein the right and left directional indicators 22 are responsive to the first multiple of the bearing angle to the source of the predetermined radio signal. In additional variations, this embodiment can further comprise a center directional indicator 22, wherein the center directional indicator 22 is responsive to the first multiple of the bearing angle to the source of the predetermined radio signal.

Refer to FIGS. 5 and 6. This embodiment can be enhanced by further comprising:
a second loop antenna 1 adapted to be responsive to the predetermined radio signal, the second loop antenna 1 capable of supplying a second loop output signal upon interaction with the predetermined radio signal, wherein the second loop antenna 1 is oriented at a non-zero-degree angle relative to the first loop antenna 2, and wherein the second loop antenna 1 is adapted such that the phase of the second loop output signal varies as the second loop antenna 1 is moved in a plane intersecting the predetermined radio signal; and
a second phase comparator 15 directly responsive to the phase difference between the second loop output signal 7 and the reference output signal 9, wherein the second phase comparator 15 is adapted to generate a second multiple of the bearing angle from the apparatus to the source of the predetermined radio signal.

This two-loop-antenna variation of this embodiment can be enhanced wherein the first loop antenna 2 is of an electrical size selected from the group consisting of small-loop antennas and medium-loop antennas; and wherein the second loop antenna 1 is of an electrical size selected from the group consisting of small-loop antennas and medium-loop antennas.

This embodiment can be enhanced by further comprising a microprocessor 19 that is responsive to both the first and second multiples of the bearing angle from the apparatus to the source of the predetermined radio signal by generating a unified bearing angle signal based on those multiples.

This embodiment can be enhanced by further comprising directional indicators 22 responsive to said unified bearing angle signal.

This embodiment can be further enhanced wherein the winding direction of the second loop antenna 1 is reversed from the winding direction of the first loop antenna 2, the second loop antenna 1 supplying a reversed second loop output signal.

This embodiment can be enhanced by further comprising a third phase comparator 13 directly responsive to the phase difference between the first loop output signal 8 and reversed second loop output signal 7, wherein the third phase comparator 13 is adapted to generate a third multiple of the bearing angle from the apparatus to the source of the predetermined radio signal. In other variations, the addition of the third multiple of the bearing angle from the apparatus to the source of the predetermined radio signal substantially doubles the directional sensitivity of the apparatus to the source of the predetermined radio signal, as compared to the directional sensitivity of an apparatus that relies only on the first and second multiples of the bearing angle from the apparatus to source of the predetermined radio signal.

This embodiment can be further be enhanced by further comprising a microprocessor 19 that is responsive to the first, second, and third multiples of the bearing angle from the apparatus to the source of the predetermined radio signal by generating a unified bearing angle signal based on those multiples. In other variations, this embodiment can be enhanced by further comprising directional indicators 22 responsive to the unified bearing angle signal and/or responsive to the first, second, and third multiples of the bearing angle from the apparatus to the source of the predetermined radio signal.

This embodiment can be enhanced by further comprising a programmed phase-difference-calculation means (see the discussion in the Third Embodiment, described supra) to calculate the phase difference between the first loop multiple output signal of the bearing angle and the second reversed second loop multiple output signal of the bearing angle such that the phase-difference calculation generates the third multiple of the bearing angle from the apparatus to the source of the predetermined radio signal.

### Sixth Embodiment

### A Method of Making a Multi-Antenna RF-Direction-Finding Receiver

This embodiment is directed generally to a method of making a direction-finding receiver that determines the originating direction of the received radio-signal source, which in some variations is adapted to be readily portable. Refer to FIG. 4. In this embodiment, the method comprises the steps of:
Providing a first loop antenna 2 adapted to be responsive to a predetermined radio signal, the first loop antenna 2 capable of supplying a first loop output signal upon interaction with the predetermined radio signal, wherein the first loop antenna 2 is adapted such that the phase of the first loop output signal varies as the first loop antenna 2 is moved in a plane intersecting the transmitter's emissions;
Providing a reference antenna 3 adapted to be responsive to the predetermined radio signal, the reference antenna 3 capable of supplying a reference output signal upon interaction with the predetermined radio signal, wherein the reference antenna 3 is adapted such that the phase of the reference output signal does not vary substantially as the reference antenna 3 is moved in the plane intersecting the transmitter's emissions; and
Providing a first phase comparator 14 directly responsive to the phase difference between the first loop output signal 8 and the reference output signal 9, wherein the first phase comparator 14 is adapted to generate a first multiple of the bearing angle from the apparatus to the source of the predetermined radio signal.

This embodiment can be further enhanced wherein the first loop antenna 2 is of an electrical size selected from the group consisting of small-loop antennas and medium-loop antennas.

This embodiment can be enhanced by further comprising the steps of providing right and left directional indicators 22, wherein the right and left directional indicators 22 are responsive to the first multiple of the bearing angle to the source of the predetermined radio signal. In additional variations, this embodiment can further comprise the step of providing a center directional indicator 22, wherein the center directional indicator 22 is responsive to the first multiple of the bearing angle to the source of the predetermined radio signal.

Refer to FIGS. 5 and 6. This embodiment can be enhanced by further comprising the steps of:
Providing a second loop antenna 1 adapted to be responsive to the predetermined radio signal, the second loop antenna 1 capable of supplying a second loop output signal upon interaction with the predetermined radio signal, wherein the second loop antenna 1 is oriented at a non-zero-degree angle relative to the first loop antenna 2, and wherein the second loop antenna 1 is adapted such that the phase of the second loop output signal varies as the second loop antenna 1 is moved in a plane intersecting the transmitter's emissions; and
Providing a second phase comparator 15 directly responsive to the phase difference between the second loop output signal 7 and the reference output signal 9, wherein the second phase comparator 15 is adapted to generate a second multiple of the bearing angle from the apparatus to the source of the predetermined radio signal.

This two-loop-antenna variation of this embodiment can be enhanced wherein the first loop antenna 2 is of an electrical size selected from the group consisting of small-loop antennas and medium-loop antennas; and wherein the second loop antenna 1 is of an electrical size selected from the group consisting of small-loop antennas and medium-loop antennas.

This embodiment can be enhanced by further comprising the step of providing a microprocessor 19 that is responsive to both the first and second multiples of the bearing angle from the apparatus to the source of the predetermined radio signal by generating a unified bearing angle signal based on the multiples.

This embodiment can be enhanced by further comprising the step of providing directional indicators 22 responsive to said unified bearing angle signal.

This embodiment can be further enhanced wherein the winding direction of the second loop antenna 1 is reversed from the winding direction of the first loop antenna 2, the second loop antenna 1 supplying a reversed second loop output signal.

This embodiment can be enhanced by further comprising the step of providing a third phase comparator 13 directly responsive to the phase difference between the first loop output signal 8 and reversed second loop output signal 7, wherein the third phase comparator 13 is adapted to generate a third multiple of the bearing angle from the apparatus to the source of the predetermined radio signal. In other variations, the addition of the third multiple of the bearing angle from the apparatus to the source of the predetermined radio signal substantially doubles the directional sensitivity of the apparatus to the source of the predetermined radio signal, as compared to the directional sensitivity of an apparatus that relies only on the first multiple and the second multiple of the bearing angle from the apparatus to the source of the predetermined radio signal.

This embodiment can be further be enhanced by further comprising the step of providing a microprocessor 19 that is responsive to the first, second, and third multiples of the bearing angle from the apparatus to the source of the predetermined radio signal by generating a unified bearing angle signal based on those multiples. In other variations, this embodiment can be enhanced by further comprising the step of providing directional indicators 22 responsive to the unified bearing angle signal and/or responsive to the first, second, and third multiples of the bearing angle from the apparatus to the source of the predetermined radio signal.

This embodiment can be enhanced by further comprising the step of providing a programmed phase-difference-calculation means (see the discussion in the Third Embodiment, described supra) to calculate the phase difference between the first loop multiple output signal of the bearing angle and the second reversed second loop multiple output signal of the bearing angle such that the phase-difference calculation generates the third multiple of the bearing angle from the apparatus to the source of the predetermined radio signal.

### Seventh Embodiment

### A Method of Using a Dual-Antenna RF-Direction-Finding Receiver

This embodiment is directed generally to a method for determining the originating direction of a transmitted radio signal, which in some variations is adapted to be readily portable, the transmitted signal emitting from a source whose signal strength and wavelength are approximately known (such as an emergency locator radio beacon installed in a transportation vehicle of some sort). In this embodiment, the method comprises the steps of:
Obtaining a dual-antenna apparatus for determining the bearing angle to a transmitter emitting radiation with respect to an energy-receiving antenna according to the First or Fifth Embodiments, described supra;
Turning on the apparatus;
Observing directional indicators on the display of the apparatus;
Rotating the apparatus to the left or right, and/or pitching the apparatus up or down, as necessary, according to indications from the directional indicators, wherein the real-time changes in the incident bearing angle toward the transmitter result in ongoing changes to the directional indications in order to give a more-refined indication of the originating direction of the transmitted signal;
Moving in the direction indicated by the apparatus display; and
As necessary, repeating the rotating and moving steps until the origin of the transmitter is located.

This embodiment can be further enhanced wherein the first loop antenna is of an electrical size selected from the group consisting of small-loop antennas and medium-loop antennas.

This embodiment can be further enhanced wherein the transmitter source is selected from the group consisting of Emergency Position-Indicating Radio Beacons (EPIRBs), Emergency Location Transmitters (ELTs), and personal location devices.

### Eighth Embodiment

### A Method of Using a Three-Antenna RF-Direction-Finding Receiver

This embodiment is directed generally to a method for determining the originating direction of a transmitted radio signal, which in some variations is adapted to be readily portable, the transmitted signal emitting from a source whose signal strength and wavelength are approximately known (such as an emergency locator radio beacon installed in a transportation vehicle of some sort). In this embodiment, the method comprises the steps of:
Obtaining a three-antenna apparatus for determining the bearing angle to a transmitter emitting radiation with respect to an energy-receiving antenna according to the second, Third, Fourth, or Fifth Embodiments, described supra;
Turning on the apparatus;
Observing directional indicators on the display of the apparatus;
Rotating the apparatus to the left or right, and/or pitching the apparatus up or down, as necessary, according to indications from the directional indicators, wherein the real-time changes in the incident bearing angle toward the transmitter result in ongoing changes to the directional indications in order to give a more-refined indication of the originating direction of the transmitted signal;
Moving in the direction indicated by the apparatus display; and
As necessary, repeating the rotating and moving steps until the origin of the transmitter is located.

This embodiment can be further enhanced wherein the first loop antenna is of an electrical size selected from the group consisting of small-loop antennas and medium-loop antennas, and wherein the second loop antenna is of an electrical size selected from the group consisting of small-loop antennas and medium-loop antennas.

This embodiment can be further enhanced wherein the transmitter source is selected from the group consisting of Emergency Position-Indicating Radio Beacons (EPIRBs), Emergency Location Transmitters (ELTs), and personal location devices.

### Alternative Embodiments and Other Variations

The various embodiments and variations thereof described herein and/or illustrated in the accompanying Figures are merely exemplary and are not meant to limit the scope of the inventive disclosure. It should be appreciated that numerous variations of the invention have been contemplated as would be obvious to one of ordinary skill in the art with the benefit of this disclosure.

Hence, those ordinarily skilled in the art will have no difficulty devising a myriad of obvious variations and improvements to the invention, all of which are intended to be encompassed within the scope of the claims which follow.

What is claimed is:

1. An apparatus for determining the bearing angle to a transmitter emitting radiation with respect to said apparatus, comprising:
a first loop antenna adapted to be responsive to a predetermined radio signal, said first loop antenna capable of supplying a first loop output signal upon interaction with said predetermined radio signal,
wherein said first loop antenna is adapted such that the phase of said first loop output signal varies as said apparatus is moved in a plane intersecting said predetermined radio signal;
a reference antenna adapted to be responsive to said predetermined radio signal, said reference antenna capable of supplying a reference output signal upon interaction with said predetermined radio signal,
wherein said reference antenna is adapted such that the phase of said reference output signal does not vary substantially as said apparatus is moved in said plane intersecting said predetermined radio signal; and
a first phase comparator directly responsive to the phase difference between said first loop output signal and said reference output signal,
wherein said first phase comparator is adapted to generate a first multiple of the bearing angle from said apparatus to the source of said predetermined radio signal.

2. The apparatus of claim 1, wherein said first loop antenna is of an electrical size selected from the group consisting of small-loop antennas and medium-loop antennas.

3. The apparatus of claim 1, further comprising right and left directional indicators,
wherein said right and left directional indicators are responsive to said first multiple of the bearing angle to the source of said predetermined radio signal.

4. The apparatus of claim 3, further comprising a center directional indicator,
wherein said center directional indicator is responsive to said first multiple of the bearing angle from said apparatus to the source of said predetermined radio signal.

5. The apparatus of claim 1, further comprising:
a second loop antenna adapted to be responsive to a predetermined radio signal, said second loop antenna capable of supplying a second loop output signal upon interaction with said predetermined radio signal,
wherein said second loop antenna is oriented at a non-zero-degree angle relative to said first loop antenna, and
wherein said second loop antenna is adapted such that the phase of said second loop output signal varies as said apparatus is moved in a plane intersecting said predetermined radio signal; and
a second phase comparator directly responsive to the phase difference between said second loop output signal and said reference output signal,
wherein said second phase comparator is adapted to generate a second multiple of the bearing angle from said apparatus to the source of said predetermined radio signal.

6. The apparatus of claim 5, wherein said second loop antenna is of an electrical size selected from the group consisting of small-loop antennas and medium-loop antennas.

7. The apparatus of claim 5, further comprising a microprocessor that is responsive to both said first and second multiples of said bearing angle from said apparatus to the source of said predetermined radio signal by generating a unified bearing angle signal based on said first and second multiples.

8. The apparatus of claim 7, further comprising directional indicators responsive to said unified bearing angle signal.

9. The apparatus of claim 5, further comprising directional indicators responsive to said first and second multiples of said bearing angle from said apparatus to the source of said predetermined radio signal.

10. The apparatus of claim 5, wherein the winding direction of said second loop antenna is reversed from the winding direction of said first loop antenna, said second loop antenna supplying a reversed second loop output signal.

11. The apparatus of claim 10, further comprising a third phase comparator directly responsive to the phase difference between said first loop output signal and said reversed second loop output signal,
wherein said third phase comparator is adapted to generate a third multiple of the bearing angle from said apparatus to the source of said predetermined radio signal.

12. The apparatus of claim 11, wherein the addition of said third multiple of said bearing angle from said apparatus to the source of said predetermined radio signal substantially doubles the directional sensitivity of said apparatus to the source of said predetermined radio signal, as compared to the directional sensitivity of an apparatus that relies only on said first and second multiples of the bearing angle from said apparatus to the source of said predetermined radio signal.

13. The apparatus of claim 11, further comprising a microprocessor that is responsive to said first, second, and third multiples of said bearing angle from said apparatus to the source of said predetermined radio signal by generating a unified bearing angle signal based on said multiples.

14. The apparatus of claim 13, further comprising directional indicators responsive to said unified bearing angle signal.

15. The apparatus of claim 11, further comprising directional indicators responsive to said first, second, and third multiples of said bearing angle from said apparatus to the source of said predetermined radio signal.

16. The apparatus of claim 10, further comprising a programmed phase-difference-calculation means to calculate the phase difference between said first multiple of the bearing angle and said second multiple of the bearing angle such that said phase-difference calculation generates a third multiple of the bearing angle from said apparatus to the source of said predetermined radio signal.

17. A method for making an apparatus for determining the bearing angle to a transmitter emitting radiation with respect to said apparatus, comprising the steps of:
providing a first loop antenna adapted to be responsive to a predetermined radio signal, said first loop antenna capable of supplying a first loop output signal upon interaction with said predetermined radio signal,
wherein said first loop antenna is adapted such that the phase of said first loop output signal varies as said apparatus is moved in a plane intersecting said predetermined radio signal;
providing a reference antenna adapted to be responsive to said predetermined radio signal, said reference antenna capable of supplying a reference output signal upon interaction with said predetermined radio signal,
wherein said reference antenna is adapted such that the phase of said reference output signal does not vary substantially as said apparatus is moved in said plane intersecting said predetermined radio signal; and
providing a first phase comparator directly responsive to the phase difference between said first loop output signal and said reference output signal,
wherein said first phase comparator is adapted to generate a first multiple of the bearing angle from said apparatus to the source of said predetermined radio signal.

18. The method of claim 17, wherein said first loop antenna is of an electrical size selected from the group consisting of small-loop antennas and medium-loop antennas.

19. The method of claim 17, further comprising the step of providing right and left directional indicators,
wherein said right and left directional indicators are responsive to said first multiple of the bearing angle from said apparatus to the source of said predetermined radio signal.

20. The method of claim 19, further comprising the step of providing a center directional indicator,
wherein said center directional indicator is responsive to said first multiple of the bearing angle from said apparatus to the source of said predetermined radio signal.

21. The method of claim 17, further comprising the steps of:
providing a second loop antenna adapted to be responsive to a predetermined radio signal, said second loop antenna capable of supplying a second loop output signal upon interaction with said predetermined radio signal,
wherein said second loop antenna is oriented at a non-zero-degree angle relative to said first loop antenna, and
wherein said second loop antenna is adapted such that the phase of said second loop output signal varies as said apparatus is moved in a plane intersecting said predetermined radio signal; and
providing a second phase comparator directly responsive to the phase difference between said second loop output signal and said reference output signal,
wherein said second phase comparator is adapted to generate a second multiple of the bearing angle from said apparatus to the source of said predetermined radio signal.

22. The method of claim 21, wherein said second loop antenna is of an electrical size selected from the group consisting of small-loop antennas and medium-loop antennas.

23. The method of claim 21, further comprising the step of providing a microprocessor that is responsive to both said first and second multiples of said bearing angle from said apparatus to the source of said predetermined radio signal by generating a unified bearing angle signal based on said first and second multiples.

24. The method of claim 23, further comprising the step of providing directional indicators responsive to said unified bearing angle signal.

25. The method of claim 21, further comprising the step of providing directional indicators responsive to said first and second multiples of said bearing angle from said apparatus to the source of said predetermined radio signal.

26. The method of claim 21, wherein the winding direction of said second loop antenna is reversed from the winding direction of said first loop antenna, said second loop antenna supplying a reversed second loop output signal.

27. The method of claim 26, further comprising the step of providing a third phase comparator directly responsive to the phase difference between said first loop output signal and said reversed second loop output signal,
wherein said third phase comparator is adapted to generate a third multiple of the bearing angle from said apparatus to the source of said predetermined radio signal.

28. The method of claim 27, wherein the addition of said third multiple of said bearing angle from said apparatus to the source of said predetermined radio signal substantially doubles the directional sensitivity of said apparatus to the source of said predetermined radio signal, as compared to the directional sensitivity of an apparatus that relies only on said first and second multiples of the bearing angle from said apparatus to the source of said predetermined radio signal.

29. The apparatus of claim 27, further comprising the step of providing a microprocessor that is responsive to said first, second, and third multiple of said bearing angle from said apparatus to the source of said predetermined radio signal by generating a unified bearing angle signal based on said multiples.

30. The method of claim 29, further comprising the step of providing directional indicators responsive to said unified bearing angle signal.

31. The method of claim 27, further comprising the step of providing directional indicators responsive to said first, second, and third multiples of said bearing angle from said apparatus to the source of said predetermined radio signal.

32. The method of claim 26, further comprising the step of providing a programmed phase-difference-calculation means to calculate the phase difference between said first loop multiple output signal of said bearing angle and said second reversed second loop multiple output signal of said bearing angle such that said phase-difference calculation generates a third multiple of the bearing angle from said apparatus to the source of said predetermined radio signal.

33. A method of determining the originating direction of a transmitted radio signal, said transmitted radio signal emitting from a source whose signal strength and wavelength are approximately known, the method comprising the steps of:
obtaining an apparatus for determining the bearing angle to a transmitter emitting radiation with respect to said apparatus, according to claim 4;
turning on said apparatus;
observing directional indicators on the display of said apparatus;
rotating said apparatus to the left or right, and/or pitching said apparatus up or down, as necessary, according to indications from said directional indicators,
wherein the real-time changes in the incident bearing angle toward said source of said transmitted radio signal result in ongoing changes to said directional indications in order to give a more-refined indication of the originating direction of said transmitted radio signal;
moving in the direction indicated by said apparatus display;
as necessary, repeating said rotating and moving steps until said origin of said transmitted radio signal is located.

34. The method of claim 33, wherein said first loop antenna is of an electrical size selected from the group consisting of small-loop antennas and medium-loop antennas.

35. The method of claim 33, wherein said transmitter radio signal source is selected from the group consisting of Emergency Position-Indicating Radio Beacons (EPIRBs), Emergency Location Transmitters (ELTs), and personal location devices.

36. A method of determining the originating direction of a transmitted radio signal, said transmitted radio signal emitting from a source whose signal strength and wavelength are approximately known, the method comprising the steps of:
obtaining an apparatus for determining the bearing angle to a transmitter emitting radiation with respect to said apparatus, according to claim 15;
turning on said apparatus;
observing directional indicators on the display of said apparatus;
rotating said apparatus to the left or right, and/or pitching said apparatus up or down, as necessary, according to indications from said directional indicators,
wherein the real-time changes in the incident bearing angle toward said source of transmitted radio signal result in ongoing changes to said directional indications in order to give a more-refined indication of the originating direction of said transmitted radio signal;
moving in the direction indicated by said apparatus display;
as necessary, repeating said rotating and moving steps until said origin of said transmitted radio signal is located.

37. The method of claim 36, wherein:
said first loop antenna is of an electrical size selected from the group consisting of small-loop antennas and medium-loop antennas; and
said second loop antenna is of an electrical size selected from the group consisting of small-loop antennas and medium-loop antennas.

38. The method of claim 36, wherein said transmitter source is selected from the group consisting of Emergency Position-Indicating Radio Beacons (EPIRBs), Emergency Location Transmitters (ELTs), and personal location devices.
